(19) United States
(12) Patent Application Publication
(10) Pub. No.: US 2017/0032336 A1
(43) Pub. Date: Feb. 2, 2017

(54) LIVE FAN-ARTIST INTERACTION SYSTEM AND METHOD

(71) Applicants: Randy G. Connell, Arvada, CO (US); Erin K. Schlicht, Arvada, CO (US); Billy Long, Thornton, CO (US)

(72) Inventors: Randy G. Connell, Arvada, CO (US); Erin K. Schlicht, Arvada, CO (US); Billy Long, Thornton, CO (US)

(21) Appl. No.: 15/221,075

(22) Filed: Jul. 27, 2016

Related U.S. Application Data
(60) Provisional application No. 62/197,886, filed on Jul. 28, 2015.

(51) Int. Cl. G06Q 20/10; H04L 29/08

(52) U.S. Cl. CPC G06Q 20/10; H04L 67/18; H04L 67/306; H04L 67/10

(57) ABSTRACT

A live fan-artist interaction system and method. The system includes an artist module having set information stored in a memory device. The artist module includes a live event display module that displays and updates set information in real-time. The system includes a plurality of fan modules each having a user interface module that each solicits set modification information in real-time during a live artist performance. The system includes an interaction module functionally coupled over a computerized network to each of the plurality of fan modules and also to the artist module such that the interaction module receives set modification information from the plurality of fan modules, which thereby determines set modification instructions and transmits set modification instructions to the artist module in real-time during a live artist performance.

### CROSS-REFERENCE TO RELATED APPLICATIONS

This invention claims priority, under 35 U.S.C. §120, to the U.S. Provisional Patent Application No. 62/197,886 to Randy G. Connell et al. filed on Jul. 28, 2015, which is incorporated by reference herein.

### BACKGROUND OF THE INVENTION

Field of the Invention

The present invention relates to music systems, specifically to a fan-artist interaction system and method.

Description of the Related Art

A concert is a live music performance in front of an audience. A recital is a concert by a soloist or small group which follows a program, such as featuring the works of a single composer. A recitalist is a musician who gives frequent recitals. Such a performance may be by a single musician, sometimes then called a recital, or by a musical ensemble, such as an orchestra, choir, or band. Concerts are held in a wide variety and size of settings, from private houses and small nightclubs, dedicated concert halls, entertainment centers and parks to large multipurpose buildings, and even sports stadiums. Indoor concerts held in the largest venues are sometimes called arena concerts or amphitheater concerts. Regardless of venue, musicians usually perform on a stage. Concerts often require live event support with professional audio equipment. Before recorded music, concerts provided the main opportunity to hear musicians play.

Conducting a successful concert entails a large group of people with carrying talents and skills. It is important to make sure that the sound system is properly set up and that lighting is appropriate for the event. Further, complex electronics are often utilized to manage and/or control musical instruments and to make changes to sound and lighting system during the event (e.g. changing voice distortion effects in a mic system for a song that requires it).

Further, the venue itself requires management and control so that large numbers of people can enter, exit and attend safely and without discomfort. Climate control systems, ticketing systems, security systems and the like all may play a role in helping to make an event successful.

Some improvements have been made in the field. As an example, there are distributed lighting systems that include remote controlled lights that are given to audience members to hold up so that light shows can be displayed across the audience as if the audience were a pixelated display.

The inventions heretofore known suffer from a number of disadvantages which include being limited in adaptability; being limited in fan interaction; being limited in use; being limited data reporting; being limited in event experience; being limited in artist interaction; being limited in distribution; being limited event data; being limited involvement; being limited in marketing; being limited in exposure; being limited in convenience; being limited in sales; being limited advertisement; and/or being limited in access.

What is needed is a live fan-artist interaction system and method that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available live fan-artist interaction systems and methods. Accordingly, the present invention has been developed to provide a system and method of fans to interact with an artist during a live artist performance.

According to one embodiment of the invention, there is a live fan-artist interaction system. The system may include an artist module that may have set information stored in a memory device. The artist module may include a live event display module that may display and update set information in real-time. The artist module may include a production instruction module that may automatically update equipment configuration and communicates the same to audio equipment.

The system may include a plurality of fan modules each may have a user interface module that each may solicit set modification information in real-time during a live artist performance Each fan module may include a performance rating module that may store real-time rating information. Each fan module may include a purchase module to facilitate purchases over a computerized network.

The system may include an interaction module that may be functionally coupled over a computerized network to each of the plurality of fan modules and also to the artist module such that the interaction module may receive set modification information from the plurality of fan modules, which thereby determines set modification instructions and transmits set modification instructions to the artist module in real-time during a live artist performance. The artist modifies set information according to set modification instructions in real-time during a live artist performance through the artist module.

The system may include a venue module that may be functionally coupled to the plurality of fan modules and also to the interaction module such that the venue module may verify check-in at a venue for each of the plurality of fan modules and may limit communication between the interaction module and any fan modules not check-in verified. Check-in at a venue may be verified by polling geo-location from the associated fan module. The system may include a plurality of artist profiles, fan profiles, and venue profiles.

According to one embodiment of the invention, there is a method of providing a live fan-artist interaction during a live artist performance. The method may include the step of providing a live fan-artist interaction system. The system may include an artist module that may have set information stored in a memory device. The system may include a plurality of fan modules each may have a user interface module that each solicits set modification information in real-time during a live artist performance. The system may include an interaction module functionally coupled over a computerized network to each of plurality of fan modules and the artist module such that the interaction module may receive set modification information from the plurality of fan modules, which thereby may determine set modification instructions and may transmit set modification instructions to the artist module in real-time during a live artist performance. The artist modifies set information according to set modification instructions in real-time during a live artist performance. The system may include a venue module that may be functionally coupled to the plurality of fan modules and to the interaction module such that the venue module may verify check-in at a venue for each of the plurality of fan modules and may limit communication between the interaction module and any fan modules not check-in verified.

The method may include the step of creating a profile for an artist through the artist module over a computerized network. The method may include creating an event for a live artist performance; wherein the step of creating an event may include the step of picking a venue from a venue profile. The method may include the step of creating set information for the plurality of fan modules to modify and interact therewith over a computerized network. The method may include facilitating voting on set modification instructions over a computerized network. The method may include the step of running a live event display, contemporaneous in time with voting on set modification instructions, for interaction between the plurality of fan modules and the artist module through the interaction module over a computerized network. The method may include running a report on set modification instructions from data solicited from the plurality of fan modules. The method may include the step of sending set modification instructions to the artist module over a computerized network.

According to one embodiment of the invention, there is a method of providing a live fan-artist interaction during a live artist performance. The method may include the step of providing a live fan-artist interaction system. The system may include an artist module that may have set information stored in a memory device. The system may include a plurality of fan modules each may have a user interface module that each solicits set modification information in real-time during a live artist performance. The system may include an interaction module functionally coupled over a computerized network to each of plurality of fan modules and the artist module such that the interaction module may receive set modification information from the plurality of fan modules, which thereby may determine set modification instructions and may transmit set modification instructions to the artist module in real-time during a live artist performance. The artist modifies set information according to set modification instructions in real-time during a live artist performance. The system may include a venue module that may be functionally coupled to the plurality of fan modules and to the interaction module such that the venue module may verify check-in at a venue for each of the plurality of fan modules and may limit communication between the interaction module and any fan modules not check-in verified.

The method may include the step of creating a fan profile through the fan module over a computerized network. The method may include searching for a venue or artist through the fan module over a computerized network. The method may include the step of checking into a venue over a computerized network. The method may include interacting with the interaction module; wherein interacting with the interaction module includes the step of voting and rating songs by an artist during a live artist performance. The method may include the step of facilitating purchase of voting credits through a purchase module over a computerized network. The method may include the step of facilitating purchase of merchandise through the purchase module from the artist module over a computerized network.

According to one embodiment of the invention, there is a method of providing a live fan-artist interaction during a live artist performance. The method may include the step of providing a live fan-artist interaction system. The system may include an artist module that may have set information stored in a memory device. The system may include a plurality of fan modules each may have a user interface module that each solicits set modification information in real-time during a live artist performance. The system may include an interaction module functionally coupled over a computerized network to each of plurality of fan modules and the artist module such that the interaction module may receive set modification information from the plurality of fan modules, which thereby may determine set modification instructions and may transmit set modification instructions to the artist module in real-time during a live artist performance. The artist modifies set information according to set modification instructions in real-time during a live artist performance. The system may include a venue module that may be functionally coupled to the plurality of fan modules and to the interaction module such that the venue module may verify check-in at a venue for each of the plurality of fan modules and may limit communication between the interaction module and any fan modules not check-in verified.

The method may include the step of creating a venue profile through the venue module over a computerized network. The method may include the step of creating a venue event through the venue module over a computerized network. The method may include running a live event display, contemporaneous in time with voting on set modification instructions, for interaction between the plurality of fan modules and the artist module through the interaction module over a computerized network. The method may include the step of running a report on set modification instructions from data solicited from the plurality of fan modules. The method may include the step of sending set modification instructions to the artist module over a computerized network.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a perspective view of an artist performing a live artist performance in front a plurality of fans, according to one embodiment of the invention;

FIG. 2 is a network diagram of a live fan-artist interaction system, according to one embodiment of the invention;

FIG. 3 is a module diagram of a live fan-artist interaction system, according to one embodiment of the invention;

FIG. 4 is a module diagram of an artist module, according to one embodiment of the invention;

FIG. 5 is a module diagram of a fan module, according to one embodiment of the invention;

FIG. 6 is a module diagram of a venue module, according to one embodiment of the invention;

FIG. 7 is a flowchart of a live fan-artist interaction method, according to one embodiment of the invention;

FIGS. 8 and 9 are linked prophetic screenshots of a smartphone application interface of a live fan-artist interaction system, according to one embodiment of the invention;

FIGS. 10 and 11 are prophetic screen shots of a smartphone application interface of a live fan-artist interaction system, according to one embodiment of the invention;

FIGS. 12-14 are flowcharts showing creation and use of venue, fan and artist profiles, respectively; and

FIG. 15 is a sequence diagram of a live fan-artist interaction method, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Many of the functional units described in this specification have been labeled as modules in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like. Modules may also be implemented in software for execution by various types of processors. An identified module of programmable or executable code may, for instance, comprise one or more physical or logical blocks of computer instructions which may, for instance, be organized as an object, procedure, or function.

Nevertheless, the executables of an identified module need not be physically located together, but may comprise disparate instructions stored in different locations which, when joined logically together, comprise the module and achieve the stated purpose for the module. Indeed, a module and/or a program of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The various system components and/or modules discussed herein may include one or more of the following: a host server, motherboard, network, chipset or other computing system including a processor for processing digital data; a memory device coupled to a processor for storing digital data; an input digitizer coupled to a processor for inputting digital data; an application program stored in a memory device and accessible by a processor for directing processing of digital data by the processor; a display device coupled to a processor and/or a memory device for displaying information derived from digital data processed by the processor; and a plurality of databases including memory device(s) and/or hardware/software driven logical data storage structure(s).

Various databases/memory devices described herein may include records associated with one or more functions, purposes, intended beneficiaries, benefits and the like of one or more modules as described herein or as one of ordinary skill in the art would recognize as appropriate and/or like data useful in the operation of the present invention.

As those skilled in the art will appreciate, any computers discussed herein may include an operating system, such as but not limited to: Andriod, iOS, BSD, IBM z/OS, Windows Phone, Windows CE, Palm OS, Windows Vista, NT, 95/98/2000, OS X, OS2; QNX, UNIX; GNU/Linux; Solaris; MacOS; and etc., as well as various conventional support software and drivers typically associated with computers. The computers may be in a home, industrial or business environment with access to a network. In an exemplary embodiment, access is through the Internet through a commercially-available web-browser software package, including but not limited to Internet Explorer, Google Chrome, Firefox, Opera, and Safari.

The present invention may be described herein in terms of functional block components, functions, options, screen shots, user interactions, optional selections, various processing steps, features, user interfaces, and the like. Each of such described herein may be one or more modules in exemplary embodiments of the invention even if not expressly named herein as being a module. It should be appreciated that such functional blocks and etc. may be realized by any number of hardware and/or software components configured to perform the specified functions. For example, the present invention may employ various integrated circuit components, e.g., memory elements, processing elements, logic elements, scripts, look-up tables, and the like, which may carry out a variety of functions under the control of one or more microprocessors or other control devices. Similarly, the software elements of the present invention may be implemented with any programming or scripting language such as but not limited to Eiffel, Haskell, C, C++, Java, Python, COBOL, Ruby, assembler, Groovy, PERL, Ada, Visual Basic, SQL Stored Procedures, AJAX, Bean Shell, and extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention may detect or prevent security issues with a client-side scripting language, such as JavaScript, VBScript or the like.

Additionally, many of the functional units and/or modules herein are described as being “in communication” with other functional units, third party devices/systems and/or modules. Being “in communication” refers to any manner and/or way in which functional units and/or modules, such as, but not limited to, computers, networks, mobile devices, program blocks, chips, scripts, drivers, instruction sets, databases and other types of hardware and/or software, may be in communication with each other. Some non-limiting examples include communicating, sending, and/or receiving data and metadata via: a wired network, a wireless network, shared access databases, circuitry, phone lines, internet backbones, transponders, network cards, busses, satellite signals, electric signals, electrical and magnetic fields and/or pulses, and/or so forth.

As used herein, the term “network” includes any electronic communications means which incorporates both hardware and software components of such. Communication among the parties in accordance with the present invention may be accomplished through any suitable communication channels, such as, for example, a telephone network, an extranet, an intranet, Internet, point of interaction device (point of sale device, personal digital assistant, cellular phone, kiosk, etc.), online communications, off-line communications, wireless communications, transponder communications, local area network (LAN), wide area network (WAN), networked or linked devices and/or the like. Moreover, although the invention may be implemented with TCP/IP communications protocols, the invention may also be implemented using other protocols, including but not limited to IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997), the contents of which are hereby incorporated by reference.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

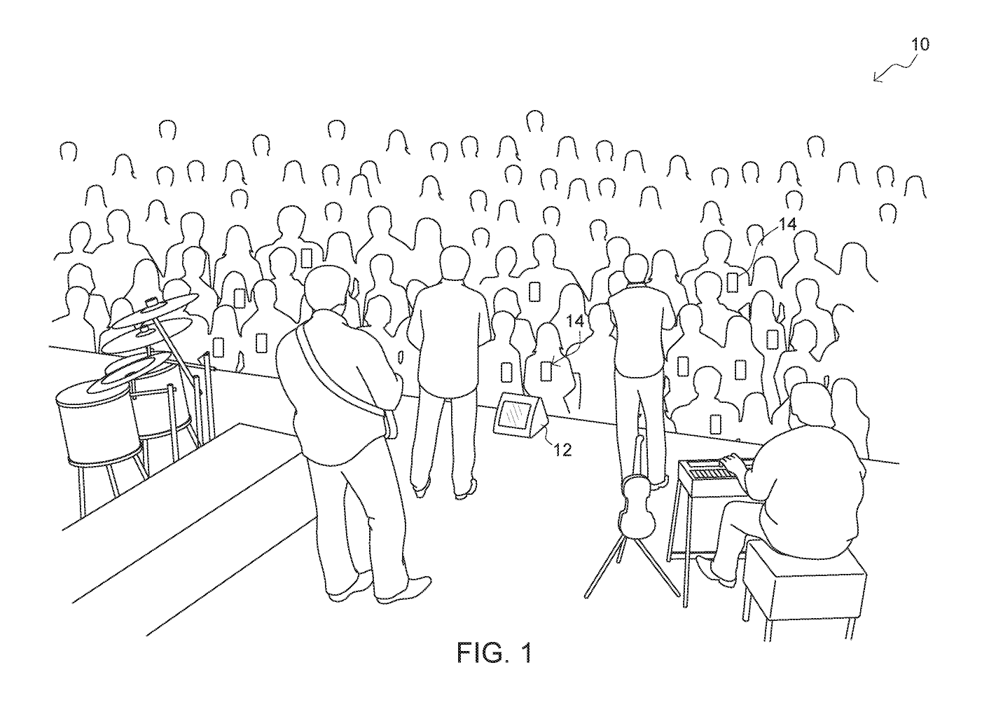

FIG. 1 is a perspective view of an artist performing a live artist performance in front a plurality of fans, according to one embodiment of the invention. There is shown an artist performing a live artist performance using a live fan-artist interaction system 10 in front a plurality of fans each of whom may be interacting through a fan module 14 over a computerized network with the artist; wherein the artist is in view of an artist module 12 through a display and the fans may modify set information in real-time during the performance by voting for songs through the fan module over a computerized network.

The illustrated artist module 12 is disposed on a stage or performance area; wherein the artist is in view of the artist module 12 when needed. The artist module 12 displays set information along with musical equipment settings and configurations for each song being performed. The artist module 12 displays set modification instructions along with production instructions for modifying the set information.

According to one embodiment of the invention, there is a live fan-artist interaction system 10 including an artist module 12 having set information stored in a memory device. The artist module 12 includes a live event display module that displays and updates set information in real-time. The artist module 12 includes a production instruction module that automatically updates equipment configuration and communicates the same to audio equipment.

The live fan-artist interaction system 10 includes a plurality of fan modules 14 each having a user interface module that each solicits set modification information in real-time during a live artist performance Each fan module 14 includes a performance rating module that stores real-time rating information. Each fan module 14 includes a purchase module to facilitate purchases over a computerized network.

The live fan-artist interaction system 10 includes an interaction module functionally coupled over a computerized network to each of the plurality of fan modules 14 and also to the artist module 12 such that the interaction module receives set modification information from the plurality of fan modules 14, which thereby determines set modification instructions and transmits set modification instructions to the artist module in real-time during a live artist performance. The artist module 12 modifies set information according to set modification instructions in real-time during a live artist performance.

The live fan-artist interaction system 10 includes a venue module functionally coupled to the plurality of fan modules 14 and also to the interaction module such that the venue module verifies check-in at a venue for each of the plurality of fan modules 14 and limits communication between the interaction module and any fan modules 14 not check-in verified. Check-in at a venue is verified by polling geo-location from the associated fan module 14. The system 10 includes a plurality of artist profiles, fan profiles, and venue profiles.

According to one embodiment of the invention, there is a live fan-artist interaction system that may be distributed over a network (e.g. wireless network, internet). On the artist side (e.g. on stage with the performers) the system may include a specialized computing device that may include one or more of: sound system controller, graphical display device, set-list management software, database, network adapter, processor, memory, bus, and device housing. There may be set information stored in a memory device. Set information would include information about a series of performance pieces for the performers to perform. Such may include song titles, musical key information, audio equipment setting information (e.g. volume, equalizer settings, audio effect settings, equipment activation information), musical instrument list, visual/audio prompt information, timing information, and the like and combinations thereof. This specialized computing device on the performer's side may be called an artist module. The display module may display and/or update one or more parts of set information and may do so in real-time such that the set information is provided to the performers on an ongoing as needed basis. This is helpful since the set information may be changing based on actions and activities in the system by and/or through actions and activities taken by audience members who are linked to the system by their own devices (e.g. apps on their smartphones/tablets). The artist module may include a production controller (e.g. production instruction module) that may automatically update equipment configuration and communicates the same to audio equipment via wired or wireless connections. As a non-limiting example, a particular song may require that an electric guitar have its treble setting increased and the production controller may do that automatically based on real-time information from the system during the event.

The system may include an application that fans can download and install on their personal computing devices (e.g. smartphones, tablets). That application may be called a fan module. Once downloaded and installed, it provides communication between the device on which it is installed and the system and includes a user interface (e.g. GUI) through which that communication may be extended to the user of the device, i.e. the fan.

The user interface for the fan(s) may solicit set modification information in real-time during a live artist performance by providing songs to vote on, set list management tools, free-form text data submission tools, interactive queries, and the like and combinations thereof. Thereby each fan may contribute set information, which may be limited to just song selection and/or order for an event, but could include other information as well. As a non-limiting example, the instruments of each performer could be tuned/equalized by the audience members (e.g. set to the average setting submitted by each audience member, set to specific settings chosen by randomly selected audience members) and such could be the case in a humorous performance or in a performance where the artists are to show off their skills, in that they can make great music even when their instruments are “messed with” by the audience. Thus, while the most common use of the system is to generate real-time set-lists with songs selected by the audience during the event and to communicate those in real-time to performers, one can recognize that any aspect of set information may be used in interaction through the system with audience members and thus the possible fan interaction uses to which this system may be put are nearly endless.

Each fan app/module may include performance rating software that may store real-time rating information (i.e. about the performance) and may communicate that to the system. Each fan app/module may include a virtual shopping cart to facilitate purchases over a computerized network so that the fans can buy event gear (e.g. t-shirts, merchandise, tickets to other events, enhanced permissions/rights/voting power within the system, music (e.g. mp3 files, CDs), collectable items, and the like and combinations thereof.

The system may include interaction management software, aka interaction module that may be functionally coupled over a computerized network to each of the plurality of fan apps and also to the artist module such that the interaction module may coordinate therebetween. It can receive set modification information from the plurality of fan apps. It may process that information (e.g. averaging, identifying which information has the most duplication among the set of fans present/registered/participating, randomly select from the pool of received information) and such processing may result in set-information modification instructions (e.g. move song 7 to place 5 in the set list because people are currently really excited about that song and so when the current song 45 finishes we want to play that popular song). The set modification instructions may be communicated automatically through and/or by the system to any attached control/display devices as appropriate to execute the change inset information. As a non-limiting example, this may be carried out by having a central data storage location for all set information and the devices may query/poll that data storage for the information that they need in order to operate properly. As set information is modified by the system in real-time that data in storage changes and as the devices request information then they receive the most updated version of that information. Devices may be set to automatically query/poll the data storage on an ongoing basis so that last-second changes in the information can be updated relatively quickly. This may solve any problems with changes being made after a song starts and one or more instruments, speakers, amplifiers, microphones, displays, lighting systems, etc. may need to have the information refreshed in order to properly operate based on the updated data.

The system may include an app for use by the venue and/or those who may be hosting the location of the event. This app may be called a venue module and it may be functionally coupled to the plurality of fan modules and/or to the interaction module such that the venue module may interact therewith. As a non-limiting example, the venue module may be functionally coupled to a ticketing system which allows the venue to block use of the system by fans that have not scanned their ticket or otherwise complied with whatever process the venue has to verify check-in at a venue. Thus the venue app may include machine readable instructions for communicating with other systems of the venue, may include user configuration settings, may facilitate interoperation of the system with the appropriate devices/systems that may be resident to the venue (e.g. house lighting/sound systems) so that those systems can benefit from updated set information within the system. The venue app may be installed on a computing device operated by the venue and allow for management and/or communication of the venue, by the venue and/or with the venue. The system may have variable settings which can change how the user interface for the venue app functions. Thus the system can customize the venue app and its permissions to work with varying venues of varying sophistication and special needs/setups.

The system may include permanent/persistent accounts for fans, artists, events and venues so that settings may be saved for each from event to event. Further, operation of the system may be enhanced by linking such accounts together in the system (e.g. using metatags) in order to operate during the event. As a non-limiting example, a plurality of artists may link their accounts to form a single “band” account. Such a band account may functionally link to a venue for a particular time period and that may linked set of accounts may create an event account (which could be repeated, e.g. an annual festival). The event account could be promoted and thereby fans link their accounts to that event (e.g. buying a ticket to go, showing support, showing an intention to go) and then when the event is getting ready to start, the venue operator can authorize fan apps that are so linked that have permission from the venue to attend and participate.

The system may be operated according to one or more specialized computerized methods that may be automatically performed by one or more devices within the system and/or one or more software tools, apps, or systems within the system. Such methods may include one or more of the following steps, presented in an order to help understand how one may make real-time changes to set information during a live event: creating a profile for an artist through the artist module over a computerized network; creating an event for a live artist performance; step of picking a venue from a venue profile; creating set information for the plurality of fan modules to modify and interact therewith over a computerized network; facilitating voting on set modification instructions over a computerized network; running a live event display that may be contemporaneous in time with voting on set modification instructions, for interaction between the plurality of fan modules and the artist module through the interaction module over a computerized network; running a report on set modification instructions from data solicited from the plurality of fan modules; and/or sending set modification instructions to the artist module over a computerized network.

Such steps may be cued or otherwise triggered automatically by the system itself and/or by user interaction through one or more apps operated by one or more fans, artists, and/or venues. Once initiated, a step may be carried out to completion by one or more computing devices coupled to the system. This may all occur simultaneous/contemporaneous with a live artistic performance Such performances are most likely to, at least initially, be popular music concerts, but could be other public/private performance settings.

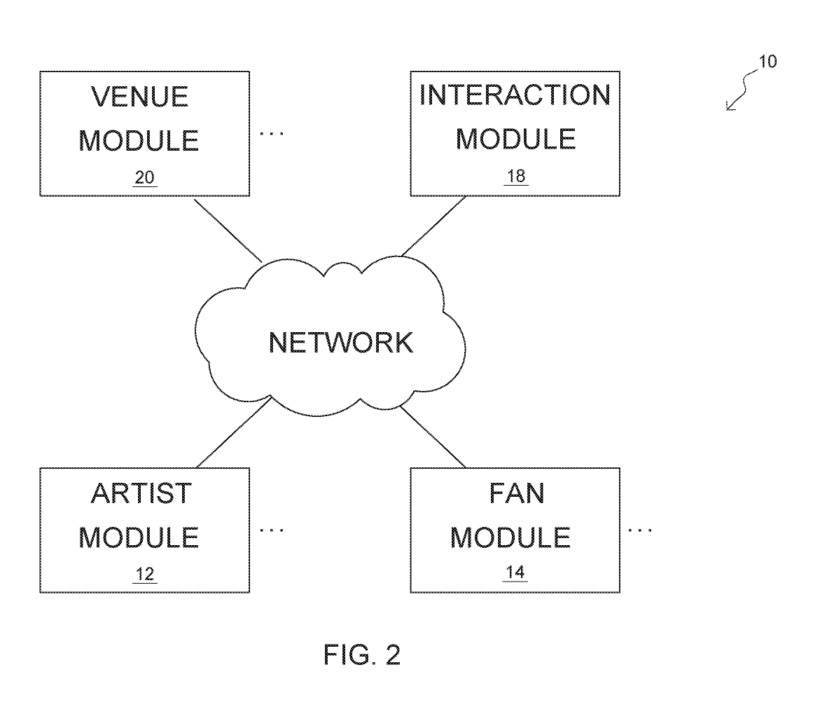

FIG. 2 is a network diagram of a live fan-artist interaction system, according to one embodiment of the invention. There is shown a live fan-artist interaction system 10 including an interaction module 18, a plurality of artist modules 12, a plurality of venue modules 20, and a plurality of fan modules 14 each in functional communication with the other over a computerized network. In operation, an influence group interacts with the plurality of fan modules 14 according to a predetermined schema that may be stored/enforced by the interaction module. The fan modules 14 provide influence information to the interaction module which then processes such influence information and publishes/enforces/distributes/pushes the processed influence information to the artist modules wherein the influence takes effect. Such will generally occur real-time during a performance so that fans in an audience may be able to interact and have influence over a performance, such as but not limited to being able to change a performance set midstream so that particular songs that the particular audience would most like to hear will be performed instead of the regular pre-planned set without interrupting the performers or requiring performance time to handle the logistics of determining what the audience would like to experience.

The interaction module 18 may include a processor, a network module, a data storage module and an instruction set for processing received influence information, storing a schema, publishing the schema to fan modules, and publishing processed influence information to artist modules. Such may be accomplished using a server connected to a network with special purpose hardware/software components configured to perform one or more of the functions described herein.

The fan modules 14 may include a processor, network module, display device, user interface device, data storage and an instruction set for presenting a user interface according to a schema, receiving user input influence information and communicating the same to an interaction module. Such may be accomplished using a smartphone/tablet computing device having special purpose hardware/software such as but not limited to a downloaded application resident on the same configured to perform one or more of the functions described herein. Fan modules may display selections that fans may select and then communicate the same to the interaction module/system wherein the displayed selections are logically associated with the collective effect that they may have on the performance after processing by the interaction module. Fan interaction may be published and/or distributed to third party systems over a communication module such as but not limited to being published to social media networks/systems (e.g. Facebook, LinkedIn, Google+), which may be managed by a social media integration module.

The artist modules 12 may simply include a display device and a network module configured to receive and display processed influence information over a network. Such may also include additional hardware if further processing and/or interaction is desired. Such may be accomplished using a simple dumb display or a smartphone with a special purpose application resident thereon. Such a module may also include one or more devices for automatically enforcing or otherwise effecting influence information, such as but not limited to automatically changing a special effect of a musical instrument (e.g. color of a guitar having variable color LED devices disposed therein, sound bank selection of an electronic keyboard, background scene of an animated character displayed in association with a performance, automatically queuing a karaoke playlist and pairing such songs with particular performers as determined by the processed influence information such that when song information is displayed the performer associated with that song is also displayed).

The venue module 20 may include a processor, a network module, a data storage module and a verification system for verifying fan module location by polling geo-location data from the fan module 14. Such may be accomplished using a server connected to a network with special purpose hardware/software components configured to perform one or more of the functions described herein.

The illustrated live fan-artist interaction system 10 is configured to provide interaction capabilities to fans of artists in real-time over a computerized network. The live fan-artist interaction system 10 includes an interaction module 18 configured to provide interaction capabilities to the fans of artists over a computerized network. The capabilities may include enabling the fans to suggest or vote on songs to be played at a live event, in real-time. The live fan-artist interaction system 10 includes a plurality of artist modules 12 in communication with the interaction module 18 over a computerized network to provide artist content and interaction capabilities over a computerized network to a plurality of fan modules 14. The fan modules 14 enable a fan to vote and suggest songs and other theatrical elements during a live event in real-time over a computerized network. The fan module 14 enables users to search for artists and purchase artist content therefrom over a computerized network.

According to one embodiment of the invention, there is a live fan-artist interaction system 10 that is configured to provide a fan and artist based application that may be used in correlation with an electronic device such as a personal cell phone. The live fan-artist interaction system 10 is configured to allow fans to influence artist set play lists during real-time events such as concerts or music festivals. The live fan-artist interaction system 10 includes a fan module 14 on a mobile electronic device and an artist module 12 on a mobile electronic device. The live fan-artist interaction system provides a two-way application that allows for coordination and interaction between the two groups through an interaction module. The interaction module is configured to provide operational controls and parameters to the artist module and to the fan module.

According to one embodiment of the invention, there is a system 10 (live fan-artist interaction system) that allows for fan influence of artist play-lists in real-time. It may be that the system includes a mobile application and/or a mobile/local device for operation by a participant in an experience (concert, exhibition, display, show, contest, competition, etc.) that receives interactive inputs from the user and provides them for use by the system. It may be that the system allows for direct and/or indirect influence (e.g. voting, lottery-style selection of influence, compilation and display of influence information for integration by performer into performance, writing/rewriting script file that controls electronic device(s) like lighting systems) which may allow for a particular individual or group of individuals (e.g. fan, DJ, fan group, club, board) to design one or more aspects, characteristics, features, contributions, elements, etc. of an event, music set, production schedule, band, set of instruments, etc. Such a system may allow for influence by people other than fans in the influence group, include people that might not be present in the influence group. The system may allow for the influence group to influence particular performers of a band instead of a whole group/band. While much of this description discusses how fans of a concert may influence a set of a performing musical group, it is understood that the system is not limited to musical artists and may be used in conjunction with performances (especially but not limited to live performances) of actors, comedians, debaters, DJs, magicians, etc. While much of this description discusses how fans of a concert may influence a set of a performing musical group, it is understood that the system is not limited to just sets/play-lists but could be play-styles, instruments to be played, roles, clothing, and/or props. While real-time interaction and influence of the system is contemplated, it may be that there is a delay between interactions and influence. Influence groups may provide full/partial interactive input pre-performance and/or post-performance and such influence may take effect fully/partially pre/during/post performance of the event/etc.

Advantageously, the system 10 may allow for new interactions between audiences and performers during real-time creating a great variety of possible enhancements to experiences for both groups. Such may prompt the invention of new types of experiences and/or provide those involved with greater satisfaction, enjoyment, profitability, efficiency of communication, connection, understanding, etc. Further, the system may promote economic growth in the many sectors, including but not limited to entertainment, personal growth/achievement, competitions, contests, sports, music, video gaming, movies, plays, comedy, etc.

According to one embodiment of the invention, there is a live fan-artist interaction system 10. The system 10 includes an artist module 12 or a plurality of artist modules 12 having set information stored in a memory device. The artist module 12 displays and updates set information in real-time. The artist module 12 automatically updates equipment configuration and communicates the same to audio equipment.

The system 10 includes a plurality of fan modules 14 each having a user interface module that each solicits set modification information in real-time during a live artist performance Each fan module 14 stores real-time rating information. Each fan module 14 facilitates purchases over a computerized network.

The system 10 includes an interaction module 18 functionally coupled over a computerized network to each of the plurality of fan modules 14 and also to the artist module 12 such that the interaction module 18 receives set modification information from the plurality of fan modules 14, which thereby determines set modification instructions and transmits set modification instructions to the artist module 12 in real-time during a live artist performance. The artist module 12 modifies set information according to set modification instructions in real-time during a live artist performance.

The system 10 includes a venue module 20 functionally coupled to the plurality of fan modules 14 and also to the interaction module 18 such that the venue module 20 verifies check-in at a venue for each of the plurality of fan modules 14 and limits communication between the interaction module 18 and any fan modules 14 not check-in verified. Check-in at a venue is verified by polling geo-location from the associated fan module 14. The system 10 includes a plurality of artist profiles, fan profiles, and venue profiles stored in the artist module 12, the fan module 14, and the venue module 20.

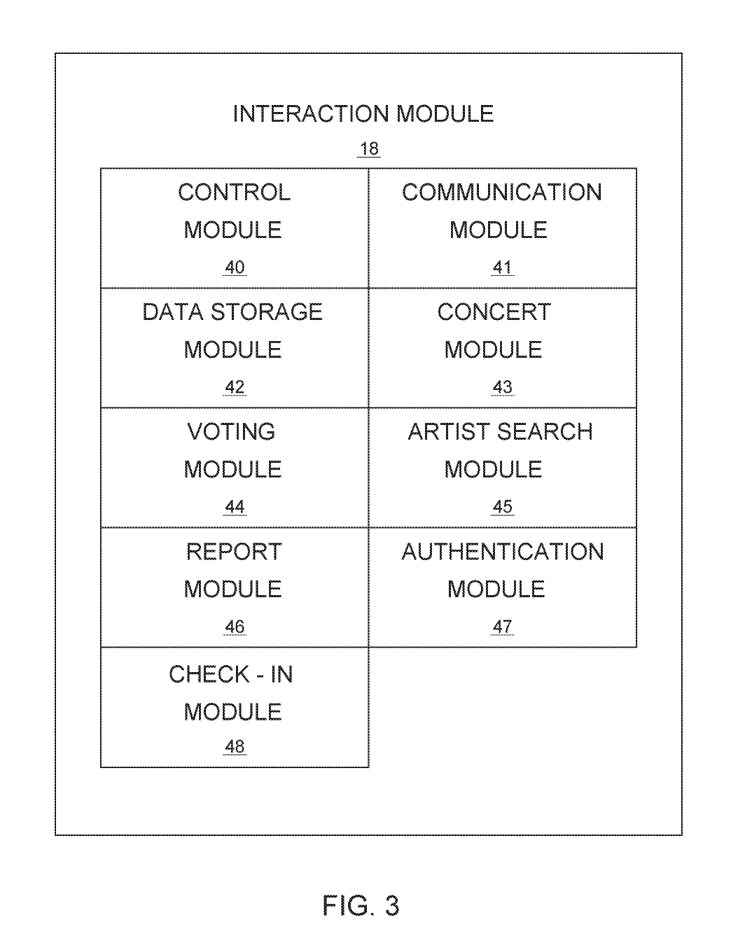

FIG. 3 is a module diagram of an interaction system of a live fan-artist interaction system, according to one embodiment of the invention. There is shown an interaction module 18 including a control module 40, a communication module 41, a data storage module 42, a concert module 43, a voting module 44, an artist search module 45, a report module 46, an authentication module 47, and a check-in module 48.

The illustrated interaction module 18 is configured to provide interaction capabilities to a plurality of fans of artists in real-time during a live event over a computerized network. The interaction module 18 includes a control module 40 functionally coupled to the modules and components of the interaction module 18 as required to function. The control module 40 is configured to manage operational controls, standards, parameters, or settings of a fan-artist interaction system. Non-limiting examples of a control module may be a control module described in U.S. Pat. No. 5,430,836, issued to Wolf et al.; or a control module described in U.S. Pat. No. 6,243,635, issued to Swan et al. which are incorporated for their supporting teachings herein. A control module may include but is not limited to a processor, a state machine, a script, a decision tree, and the like.

The illustrated interaction module 18 includes a communication module 41 in communication with one or more other modules and components of the interaction module 18 and/or in communication with one or more outside modules such as but not limited to a communication module of another user over a computerized network, such as but not limited to a smartphone. Such communication may be wireless, especially in regards to communications over a network, and/or may be wired and/or over a bus, such as may generally be found within a portable communication device. The communication module 41 may include instructions for communication protocol(s) such as but not limited to TCP/IP, Bluetooth, distributed communication networks, and the like and combinations thereof. The communication module may also be configured to provide a secure method of communication over a computerized network. Non-limiting examples of a communication module may be but not limited to: a communication module described in U.S. Pat. No. 5,307,463, issued to Hyatt et al.; or a communication module described in U.S. Pat. No. 6,133,886, issued to Fariello et al. which are incorporated for their supporting herein.

The illustrated interaction module 18 includes a data storage module 42 in communication with the various modules and components of the interaction module 18. The data storage module 42 is configured to store user data, such as artist content data and/or fan account data for use with a fan-artist interaction system. Data storage modules may be databases or data files, and the memory storage device may be hard drives or tapes. A non-limiting example of a data base is Filemaker Pro 11, manufactured by Filemaker Inc., 5261 Patrick Henry Dr., Santa Clara, Calif., 95054. Non-limiting examples of a storage module may include: a HP Storage Works P2000 G3 Modular Smart Array System, manufactured by Hewlett-Packard Company, 3000 Hanover Street, Palo Alto, Calif., 94304, USA; or a Sony Pocket Bit USB Flash Drive, manufactured by Sony Corporation of America, 550 Madison Avenue, New York, N.Y., 10022.

The illustrated interaction module 18 includes an authentication module 47 configured to authenticate users, such as artists or fans of a fan-artist interaction system. The authentication module 47 is in communication with a plurality of artist modules and a plurality of fan modules over a computerized network and is configured to authenticate the users, in real-time, at a live event. The authentication module 47 is also configured to provide a secure access to the users of the interaction module 18 every time a user logs on to a fan-artist interaction system. Non-limiting examples of an authentication module may be a system as described in U.S. Pat. No. 8,056,122, issued to Cho et al.; or a system as described in U.S. Patent Publication No.: 2008/0077796, by Lund et al., which are incorporated for their supporting teachings herein.

The illustrated interaction module 18 includes a report module 46 in communication with the data storage module 42 and the plurality of artist modules over a computerized network. The report module 46 is configured to generate a report including analysis information from the feedback from a plurality of fan modules over a computerized network. The report module 46 is configured to set parameters, criteria, characteristics, settings, preferences, listings, categories, groupings, etc. for a report, for artists to review and analyze what a fan wants during a live event, in real-time. Non-limiting examples of a report module may be a system as described in U.S. Pat. No. 7,711,581; or a report generation module as described in U.S. Patent Publication No.: 2012/0284188, which are incorporated for their supporting teachings herein.

The illustrated interaction module 18 includes a concert module 43 in communication with a plurality of artist and fan modules over a computerized network. The concert module 43 is configured to enable a user using a fan module to search for upcoming live events, such as a concert, relative to the location of the user. The concert module 43 is configured to enable a user using an artist module to update live events that the artist is participating in, such as a concert or musical festival. Non-limiting examples of a concert module may be a device as described in U.S. Pat. No. 8,205,157; or a system as described in U.S. Pat. No. 7,991,758; which are incorporated for their supporting teachings herein.

The illustrated interaction module 18 includes a voting module 44 in communication with a plurality of artist and fan modules of a fan-artist interaction system over a computerized network. The voting module 44 is configured to enable fans to vote on songs or other theatrical elements in real-time to be performed at live event. The voting module 44 is configured to collect the votes and determine which songs or other theatrical elements that the fans want to see or hear at the live event, in real-time. The voting module 44 is in communication with the report module 46 configured to provide a report to an artist of the live event of what the fans would like to see or hear at the live event. Non-limiting examples of a voting module may be a voting system as described in U.S. Pat. No. 5,878,399; or a system as described in U.S. Patent Publication 2003/0006282; which are incorporated for their supporting teachings herein.

The illustrated interaction module 18 includes an artist search module 45 in communication with the concert module 43 and the data storage module 42. The artist search module 45 is configured to provide artist search capabilities to the users of a fan-artist interaction system. The artist search module 45 is configured to provide locations of live events that an artist is performing at or attending. The users of the artists search module 45 may use a proximity search to search out genres of music in a area or certain bands and musical artists nearby. Non-limiting examples of an artist search module may be a device as described in U.S. Pat. No. 8,205,157; or a system as described in U.S. Pat. No. 7,991,758; which are incorporated for their supporting teachings herein.

The illustrated interaction module 18 includes a check-in module 48 in communication with a plurality of users of a fan-artist interaction system. The check-in module 48 is configured to enable fans and artists using a fan module or an artist module over a computerized network, to check-in to a location or live event. Non-limiting examples of a check-in module may be a system as described in U.S. Pat. No. 8,663,014; or a system or method as described in U.S. Pat. No. 7,593,740; which are incorporated for their supporting teachings herein.

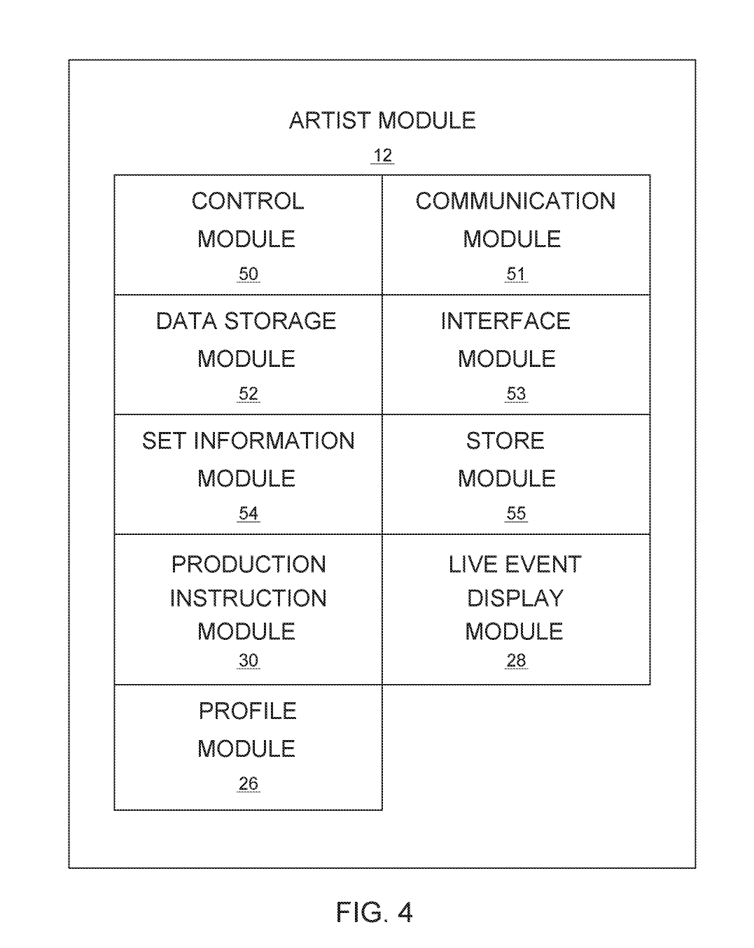

FIG. 4 is a module diagram of an artist module of a live fan-artist interaction system, according to one embodiment of the invention. There is shown an artist module 12 including a control module 50, a communication module 51, a data storage module 52, an interface module 53, a set information module 54, a store module 55, a live event display module 28, a production instruction module 30, and an artist profile module 26.

The illustrated artist module 12 is configured to provide artist interface capabilities with the interaction module and a fan-artist interaction system over a computerized network. The artist module 12 includes a control module 50 functionally coupled to the modules and components of the artist module as required to function. The control module 50 is configured to manage operational controls, standards, parameters, or settings of the artist module 12.

The illustrated artist module 12 includes a communication module in communication with one or more other modules and components of the artist module 12 and/or in communication with one or more outside modules such as but not limited to a communication module of another user over a computerized network, such as but not limited to a smartphone. Such communication may be wireless, especially in regards to communications over a network, and/or may be wired and/or over a bus, such as may generally be found within a portable communication device. The communication module 51 may include instructions for communication protocol(s) such as but not limited to TCP/IP, Bluetooth, distributed communication networks, and the like and combinations thereof. The communication module may also be configured to provide a secure method of communication over a computerized network.

The illustrated artist module 12 includes a data storage module 52 in communication with the various modules and components of the artist module 12. The data storage module 52 is configured to store user data for use with an interaction module of a fan-artist interaction system. Data storage modules may be databases or data files, and the memory storage device may be hard drives or tapes.

The illustrated artist module 12 includes an interface module 53 or an adaptive graphical user interface module. The G.U.I. module 53 is configured to provide individual user interface capabilities with the modules and components of the artist module and a fan-artist interaction system over a computerized network. The interface module 53 is configured to provide one or more interfaces for accessing the computerized system over a computerized network. Such may include one or more graphical user interfaces that may be embodied in software instructions for controlling display on a display (such as but not limited to a TV, monitor, cell phone/tablet screen, etc.) and/or for routing signals from an input device (such as but not limited to a keyboard, touchscreen, mouse, etc.) such that a user may perform data entries or queries in the computerized system, issue suggestions or recommendations, and receive data information therefrom. Such may be embodied in one or more user interfaces that permit browsing of the computerized system. Such may be embodied in one or more user interfaces that permit service personnel or administrators to make adjustments, changes, and otherwise provide personal profile or account updates to the computerized system. Such may be embodied in one or more user interfaces that permit review of data from the system, such as but not limited to template data, interactive recording data, user and usage data, management data, database usage, etc. Non-limiting examples of an interface module may be a HTML player, client server application, Java script application. A non-limiting example of an interface module is FlowPlayer 3.1, manufactured by FlowPlayer LTD, Hannuntie 8 D, ESPOO 02360, Helsinki, Finland. Non-limiting examples of a display/interface module may be a display/interface module as described in U.S. Pat. No. 6,272,562, issued to Scott et al.; a touch screen interface module as described in U.S. Pat. No. 5,884,202 and U.S. Pat. No. 6,094,609, issued to Arjomand, which are incorporated for their supporting teachings herein.

The illustrated artist module 12 includes a set information module 54 configured to provide artists the capability of uploading artist set information along with content to share over a computerized network. The set information module 54 may include artist bios, band associations, song list, set information, etc. over a computerized network. Non-limiting examples of a content module may be a system as described in U.S. Pat. No. 7,953,792; or a system described in U.S. Pat. No. 8,527,602; which are incorporated for their supporting teachings herein.

The illustrated artist module 12 includes a store module 55 configured to enable artists to sell merchandise and content over a computerized network. The store module 55 may be configured to link to an artist webpage, wherein items may be purchased over a computerized network. Non-limiting examples of a store module may be a system as described in U.S. Patent Publication No.: 2011/0060663; or a system as described in U.S. Pat. No. 8,099,365; which are incorporated for their supporting teachings herein.

The illustrated artist module 12 includes a live event display module 28 that displays and updates set information in real-time. The live event display module 28 is configured to be set up on stage or around a performing area so that an artist may view the display module 28 during a live artist performance. The live event display module 28 displays and updates set information for a song that is about to be performed. Non-limiting examples of a display module may be a display and/or projector screen modules: a 3D projection display as described in U.S. Pat. No. 5,703,717, issued to Ezra et al. is incorporated for its supported teachings; a display video apparatus as described in U.S. Pat. No. 5,132,839, issued to Travis is also incorporated for its supported teachings herein; a display/interface module may be a display/interface module as described in U.S. Pat. No. 6,272,562, issued to Scott et al.; a touch screen interface module as described in U.S. Pat. No. 5,884,202 and U.S. Pat. No. 6,094,609, issued to Arjomand, which are incorporated for their supported teachings herein.

The illustrated artist module 12 includes a production instruction module 30 that automatically updates equipment configuration and communicates the same to audio equipment. The production instruction module 30 may also control stage lighting, special effects, display monitors, sound levels, etc. during a live artist performance A non-limiting example of a production instruction module may be a data analysis module such as a Spectral Data Processor v4.5, manufactured by XPS International, 754 Leona Lane, Mountain View, Calif., 94040.

The illustrated artist module 12 includes a profile module 26 configured to manage a plurality of artist profile accounts of a fan-artist interaction system. The artist profile module 26 is configured to store and update artist profile data such as, but not limited to: bios, song lists, upcoming performances, appearances, video links, content links, etc. The profile module 26 is configured to store and reference data associated with a specific artist of the fan-artist interaction system. Non-limiting examples of a profile module may be an account creation module as described in U.S. Patent Publication No.: 2008/0281617, by Conrad et al.; or an account management system as described in U.S. Patent Publication No.: 2003/0028790, by Bleumer et all which are incorporated for their supporting teachings herein.

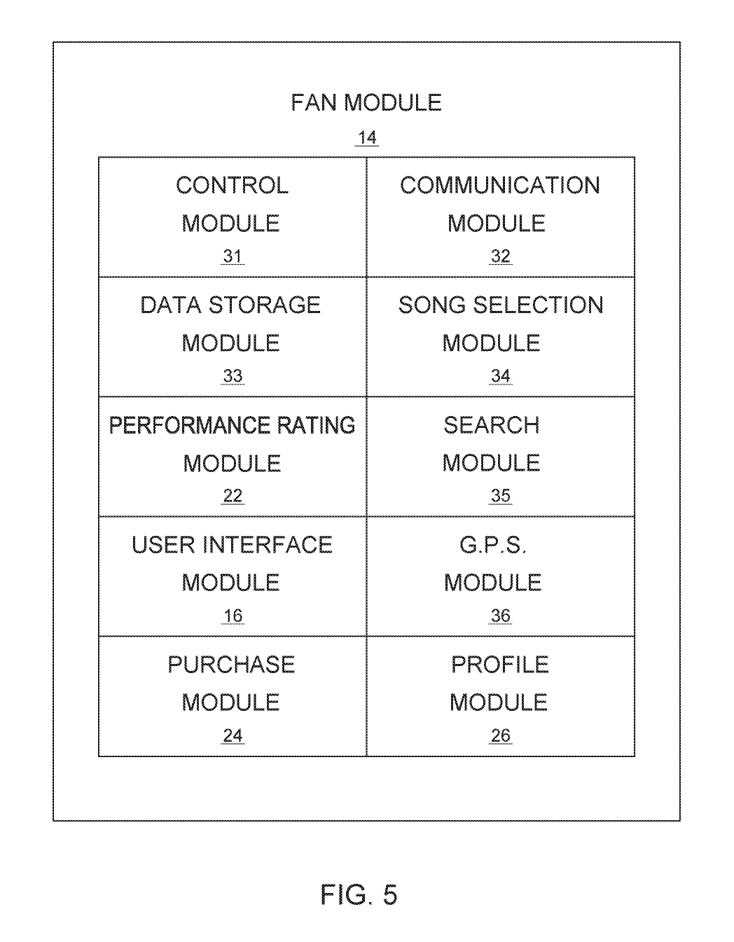

FIG. 5 is a module diagram of a fan module of a live fan-artist interaction system, according to one embodiment of the invention. There is shown a fan module 14 including a control module 31, a communication module 32, a data storage module 33, a performance rating module 22, a song selection/voting module 34, a search module 35, an user interface module 16, a global positioning module 36, a purchase module 24, and a profile module 26.

The illustrated fan module 14 is configured to provide fan interface capabilities with an interaction module of a fan-artist interaction system over a computerized network. The fan module 14 includes a control module 31 functionally coupled to the modules and components of the fan module 14 as required to function. The control module 31 is configured to manage operational controls, standards, parameters, or settings of the fan module 14.

The illustrated fan module 14 includes a communication module 32 in communication with one or more other modules and components of the fan module 14 and/or in communication with one or more outside modules such as but not limited to a communication module of another user over a computerized network, such as but not limited to a smartphone. Such communication may be wireless, especially in regards to communications over a network, and/or may be wired and/or over a bus, such as may generally be found within a portable communication device. The communication module 32 may include instructions for communication protocol(s) such as but not limited to TCP/IP, Bluetooth, distributed communication networks, and the like and combinations thereof. The communication module may also be configured to provide a secure method of communication over a computerized network.

The illustrated fan module 14 includes a data storage module 33 in communication with the various modules and components of the fan module 14. The data storage 33 module is configured to store fan or user data for use with the interaction module. Data storage modules may be databases or data files, and the memory storage device may be hard drives (e.g. SSD (solid state disks), HDD (hard drive disks)) or tapes.

The illustrated fan module 14 includes an user interface module 16 or an adaptive graphical user interface module. The user interface module 16 solicits set modification information in real-time during a live artist performance. The user interface module 16 is configured to provide individual fan or user interface capabilities with the modules and components of the fan module and the fan-artist interaction system over a computerized network. The interface module 16 is configured to provide one or more interfaces for accessing the computerized system over a computerized network. Such may include one or more graphical user interfaces that may be embodied in software instructions for controlling display on a display (such as but not limited to a TV, monitor, cell phone/tablet screen, etc.) and/or for routing signals from an input device (such as but not limited to a keyboard, touchscreen, mouse, etc.) such that a user may perform data entries or queries in the computerized system, issue suggestions or recommendations, and receive data information therefrom. Such may be embodied in one or more user interfaces that permit browsing of the computerized system. Such may be embodied in one or more user interfaces that permit service personnel or administrators to make adjustments, changes, and otherwise provide personal profile or account updates to the computerized system. Such may be embodied in one or more user interfaces that permit review of data from the system, such as but not limited to template data, interactive recording data, user and usage data, management data, database usage, etc.

The illustrated fan module 14 includes a song selection module 34 configured to provide users of the fan module 14 the ability to select songs to hear from an artist over a computerized network. The song selection module 34 may allow users of the fan module 14 to download or listen to artist music or content on a mobile computing device, such as a mobile phone, over a computerized network. A song selection module may also proffer set selection options to a user thereof during a live event and then collect, for use by the system, what selection(s) are made by the fan through the user interface of the fan. Such may be accomplished by providing option information over a graphical user interface together with instructions for how to select one or more of the options by interacting with the user interface (e.g. typing a key, touching a region of a touch screen). Once an option is selected the song selection module may communicate the selection over a network to the system. Non-limiting examples of a song selection module may be a system as described in U.S. Pat. No. 7,844,581; or a system described in U.S. Pat. No. 7,593,582; which are incorporated for their supporting teachings herein.

The illustrated fan module includes a performance rating module 22 configured to enable a user of the fan module 14 to vote for songs they want played at a live event of an artist over a computerized network. The performance rating module 22 allows users of the fan module 14 to vote on various songs or other theatrical elements of a live event, in real-time, over a computerized network. Artists may receive reports, through an artist module over a computerized network, regarding the fan voting and alter their performance at the live event to enhance the experience. Non-limiting examples of a performance rating module may be a voting system as described in U.S. Pat. No. 5,878,399; or a system as described in U.S. Patent Publication 2003/0006282; which are incorporated for their supporting teachings herein.

The illustrated fan module 14 includes a search module 35 configured to provide artist or song search capabilities to the users of the fan module 14. The search module 35 is configured to provide locations of live events that an artist is performing at or attending. The users of the search module 35 may use a proximity search to search out genres of music in a area or certain bands and musical artists nearby. Non-limiting examples of a search module may be a device as described in U.S. Pat. No. 8,205,157; or a system as described in U.S. Pat. No. 7,991,758; which are incorporated for their supporting teachings herein.

The illustrated fan module 14 includes a global positioning system module 36 associated with the fan module 14 to determine a relative location of the user of the fan module 14. The global positioning system module 36 polls a geo-location of the user of the fan module to determine or verify the location of the fan module 14. Non-limiting examples of global positioning modules include: a global positioning system described in U.S. Pat. No. 6,002,363, issued to Krasner, which is incorporated for their supported teachings herein; a Garmin e Trex Hiking GPS receiver, manufactured by Garmin International, Inc., 1200 East 151^{st} Street, Olathe, Kans., 66062, USA.

The illustrated fan module 14 includes a purchase module 24 to facilitate purchases over a computerized network. The purchase module 24 is in communication with a store module of an artist module; wherein the purchase module 24 facilitates the purchase of items or music related to an artist through an artist module of a fan-artist interaction system. Non-limiting examples of a purchase module may be an internet shopping carts, such as Big Commerce, manufactured by Interspire Inc., 9606 N. MoPac Suite 960, Austin, Tex., 78759; Shopsite Pro manufactured by Shopsite Inc., 51 West Center, #511, Orem, Utah, 84057; X-Cart:PHP Shopping Cart software manufactured by Creative Development, Krasnoarmeyskaya 111, 432071, Ulyanovsk, Russia.

The illustrated fan module 14 includes a profile module 26 configured to manage a plurality of fan profile accounts of a fan-artist interaction system. The fan profile module 26 is configured to store and update fan profile data such as, but not limited to: bios, preferences, musical genres, past performances attended, etc. The profile module 26 is configured to store and reference data associated with a specific fan of the fan-artist interaction system.

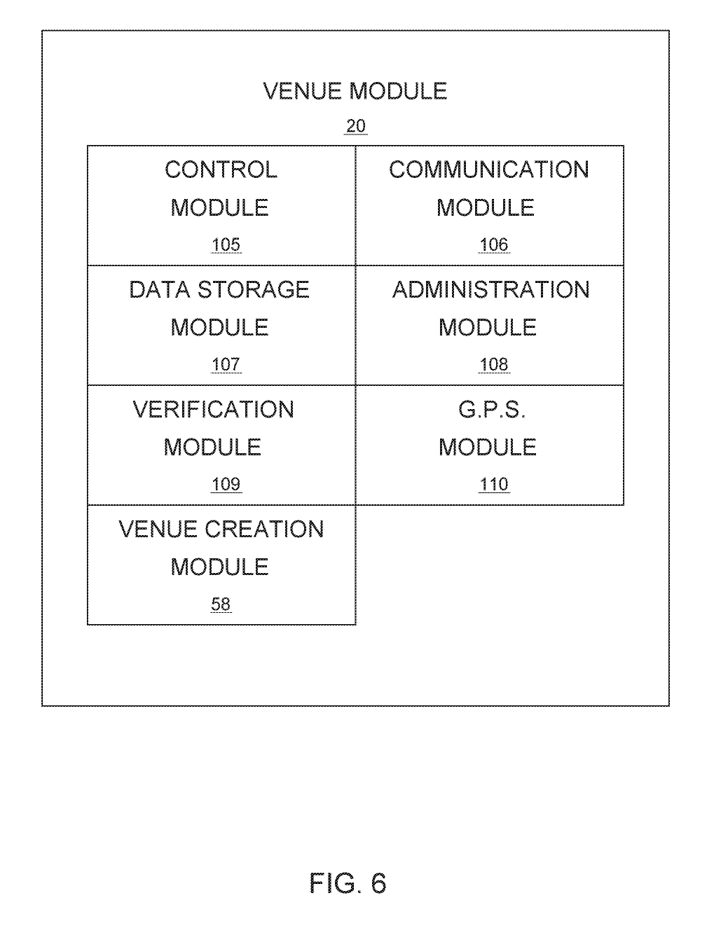

FIG. 6 is a module diagram of a venue module, according to one embodiment of the invention. There is shown a venue module 20 including a control module 105, a communication module 106, a data storage module 107, an administration module 108, a verification module 109, a G.P.S. module 110, and a venue creation module 58.

The venue module 20 includes a control module 105 functionally coupled to the modules and components of the venue module 20 as required to function. The control module 105 is configured to manage operational controls, standards, parameters, or settings of the venue module 20.

The illustrated venue module 20 includes a communication module 106 in communication with one or more other modules and components of the venue module and/or in communication with one or more outside modules such as but not limited to a communication module of another user over a computerized network, such as but not limited to a smartphone. Such communication may be wireless, especially in regards to communications over a network, and/or may be wired and/or over a bus, such as may generally be found within a portable communication device. The communication module may include instructions for communication protocol(s) such as but not limited to TCP/IP, Bluetooth, distributed communication networks, and the like and combinations thereof. The communication module may also be configured to provide a secure method of communication over a computerized network.

The illustrated venue module 20 includes a data storage module 107 in communication with the various modules and components of the venue module. The data storage module is configured to store venue data for use with an interaction module of a fan-artist interaction system. Data storage modules may be databases or data files, and the memory storage device may be hard drives (e.g. SSD (solid state disks), HDD (hard drive disks)) or tapes.

The venue module 20 includes an administration module 108 configured to provide administrative controls to an administrator of the venue module 20. The administration module 108 is configured to set and edit parameters and settings for each of the modules and components of the venue module 20. The administration module 108 is configured to generate and regulate the use of each user or administration account of the venue module or a fan-artist interaction system. Non-limiting examples of an administration module may be an administration module as described in U.S. Patent Publication No.: 2011/0125900, by Janssen et al.; or an administration module as described in U.S. Patent Publication No.: 2008/0091790, by Beck, which are incorporated for their supporting teachings herein.

The illustrated venue module 20 includes a verification module 109 configured to authenticate and verify users, such as fans or fan modules of a fan-artist interaction system. The verification module 109 is in communication with a plurality of artist modules and a plurality of fan modules over a computerized network and is configured to authenticate the users for both the artist modules and the fan modules, in real-time, at a live event or artist performance. The verification module 109 is also configured to provide a secure access to the users of the interaction module 18 every time a user logs on to a fan-artist interaction system. Non-limiting examples of an authentication module may be a system as described in U.S. Pat. No. 8,056,122, issued to Cho et al.; or a system as described in U.S. Patent Publication No.: 2008/0077796, by Lund et al., which are incorporated for their supporting teachings herein.

The illustrated venue module 20 includes a global positioning system module 110 to determine a relative location of a plurality of fans interacting through a plurality of fan modules of a fan-artist interaction system over a computerized network. The global positioning system module 110 is in communication with the verification module 109 to verify a check-in location of a user of a fan module or an artist module of a fan-artist interaction system. The global positioning system module 110 along with the verification module 109 polls a geo-location of the user of the fan module to determine or verify the location of the fan module. Non-limiting examples of global positioning modules include: a global positioning system described in U.S. Pat. No. 6,002,363, issued to Krasner, which is incorporated for their supported teachings herein; a Garmin e Trex Hiking GPS receiver, manufactured by Garmin International, Inc., 1200 East 151^{st} Street, Olathe, Kans., 66062, USA. Such GPS module may utilize GPS sensor information from portable computing devices operated by the fans and/or may utilize other sensor information, such as but not limited to wifi triangulation information, wherein such devices are in communication with the system over a local wifi system within the venue.

A venue creation module 20 may be configured to create and manage a venue profile account of an administrator of a venue using a fan-artist interaction system. The venue creation module may be configured to set up settings, preferences, access, accounts, etc. for a venue profile. The venue profile may includes geo-location of the venue, pricing, physical address, contact information, upcoming events or performances, or other related facts regarding the venue. The venue creation module may be configured to store and update venue profile data such as, but not limited to: bios, event lists, upcoming performances, pictures from previous events, content links, merchandise links, etc. The venue creation module may be a profile module which is designed to store and reference data associated with a specific venue of the fan-artist interaction system. Non-limiting examples of a venue creation module may be a profile module, such as an account creation module as described in U.S. Patent Publication No.: 2008/0281617, by Conrad et al.; or an account management system as described in U.S. Patent Publication No.: 2003/0028790, by Bleumer et all which are incorporated for their supporting teachings herein.

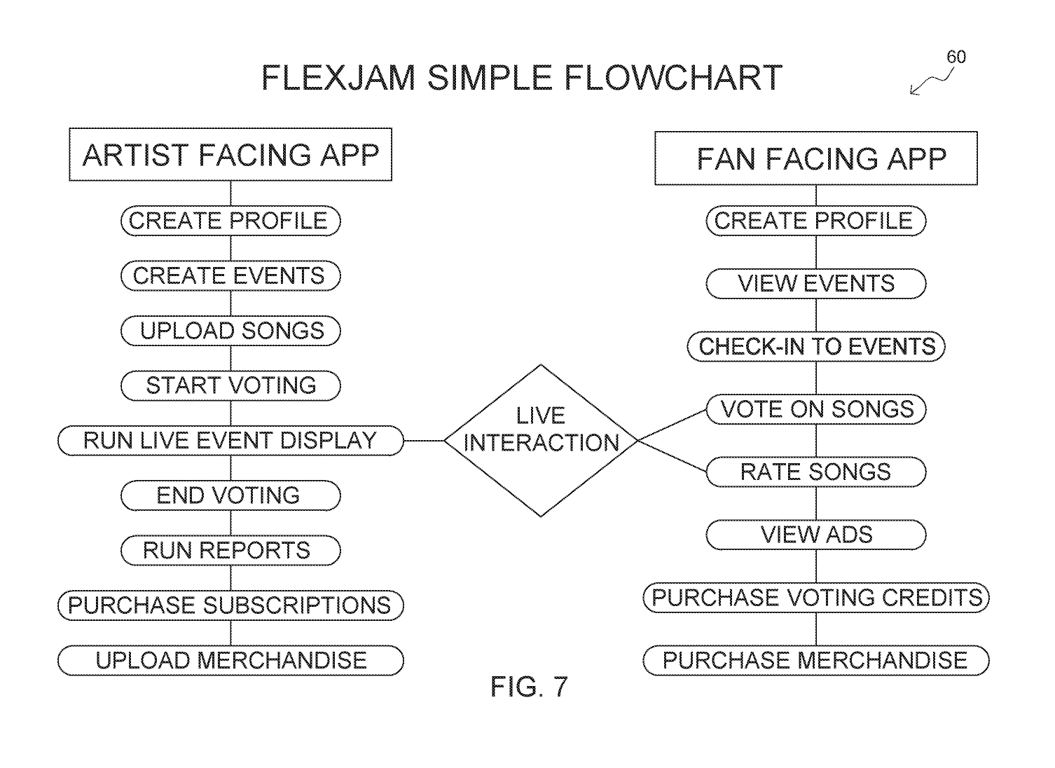

FIG. 7 is a flowchart of a live fan-artist interaction system, according to one embodiment of the invention. There is shown a method of using a live fan-artist interaction system over a computerized system 60.

The illustrated flowchart illustrates the live interaction between fan modules and artist modules over a computerized network 60. The artist module enables a user thereof to create a profile, create events, upload songs, enable or start voting, run live event displays, end voting, run reports, purchase subscriptions, and upload merchandise for fans to interact and purchase therefrom over a computerized network using an electronic mobile device. A profile may include an association with a social media network/system that may be external to the live fan-artist interaction system, but therethrough information associated with the account and/or with a social media account may be shared across systems and may be used by the other system in the operation thereof. Such may be accomplished using one or more of the modules described herein. The fan module enables a user thereof to create a profile, view and search for events, check-in to events, vote on songs or other theatrical elements, rate songs, view ads, purchase voting credits, and purchase merchandise over a computerized network using an electronic mobile device. Such may be accomplished using one or more of the modules described herein.

According to one embodiment of the invention, there is a method of providing a live fan-artist interaction during a live artist performance for an artist module administrator. The method includes the step of providing a live fan-artist interaction system over a computerized network. The system includes an artist module having set information stored in a memory device. The system includes a plurality of fan modules each having a user interface module that each solicits set modification information in real-time during a live artist performance. The system includes an interaction module functionally coupled over a computerized network to each of plurality of fan modules and the artist module such that the interaction module may receive set modification information from the plurality of fan modules, which thereby may determine set modification instructions and may transmit set modification instructions to the artist module in real-time during a live artist performance. The artist module modifies set information according to set modification instructions in real-time during a live artist performance. The system includes a venue module functionally coupled to the plurality of fan modules and to the interaction module such that the venue module may verify check-in at a venue for each of the plurality of fan modules and may limit communication between the interaction module and any fan modules not check-in verified.

The method includes the step of creating a fan profile through the fan module over a computerized network. The method includes searching for a venue or artist through the fan module over a computerized network. The method includes the step of checking into a venue over a computerized network. The method includes interacting with the interaction module; wherein interacting with the interaction module includes the step of voting and rating songs by an artist during a live artist performance. The method includes the step of facilitating purchase of voting credits through a purchase module over a computerized network. The method includes the step of facilitating purchase of merchandise through the purchase module from the artist module over a computerized network.

The method includes the step of creating a profile for an artist through the artist module over a computerized network. The method includes creating an event for a live artist performance; wherein the step of creating an event includes the step of picking a venue from a venue profile. The method includes the step of creating or relaying set information for the plurality of fan modules to modify and interact therewith over a computerized network. The method includes facilitating voting on set modification instructions over a computerized network. The method includes the step of running a live event display, contemporaneous in time with voting on set modification instructions, for interaction between the plurality of fan modules and the artist module through the interaction module over a computerized network. The method includes running a report on set modification instructions from data solicited from the plurality of fan modules. The method includes the step of sending set modification instructions to the artist module over a computerized network.

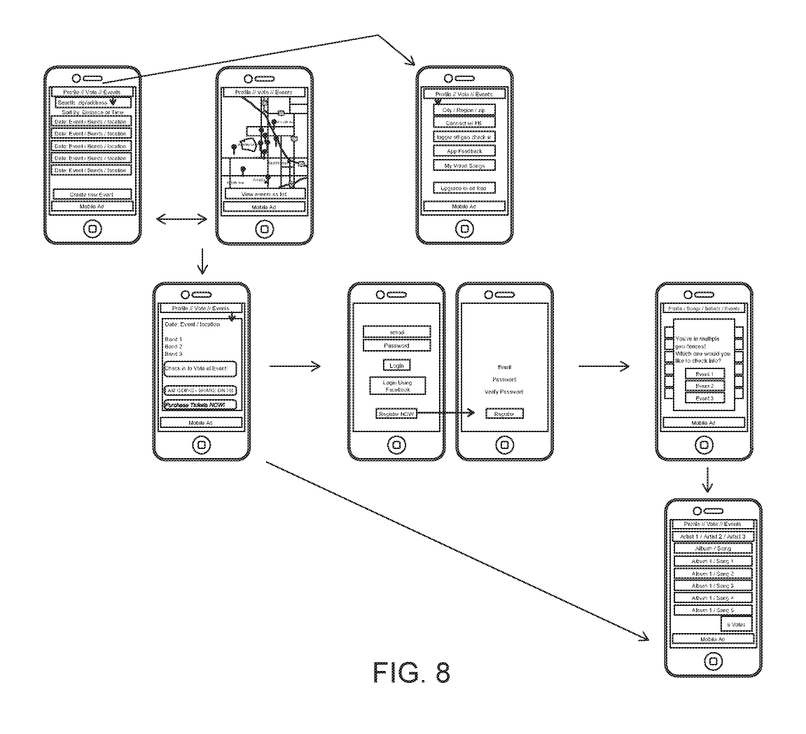

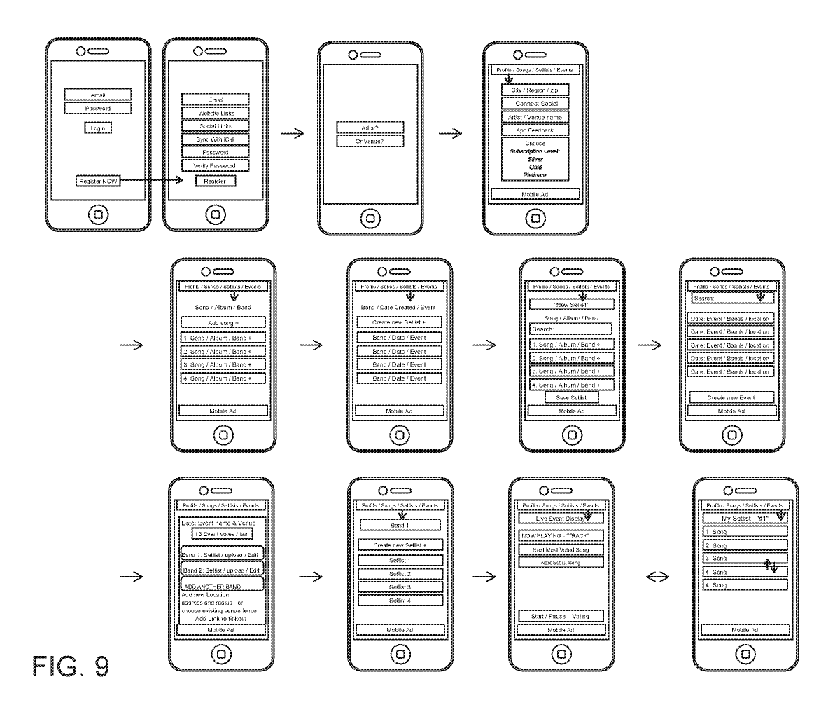

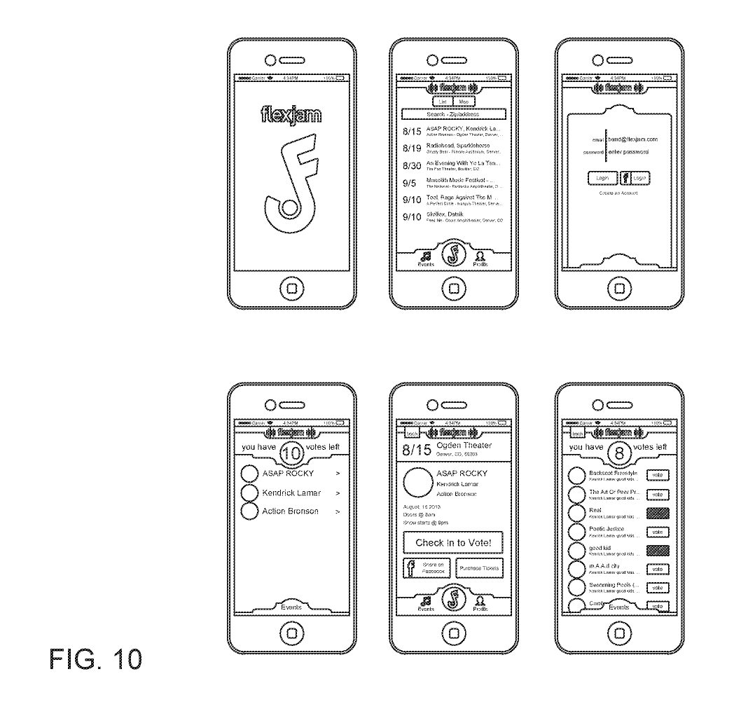

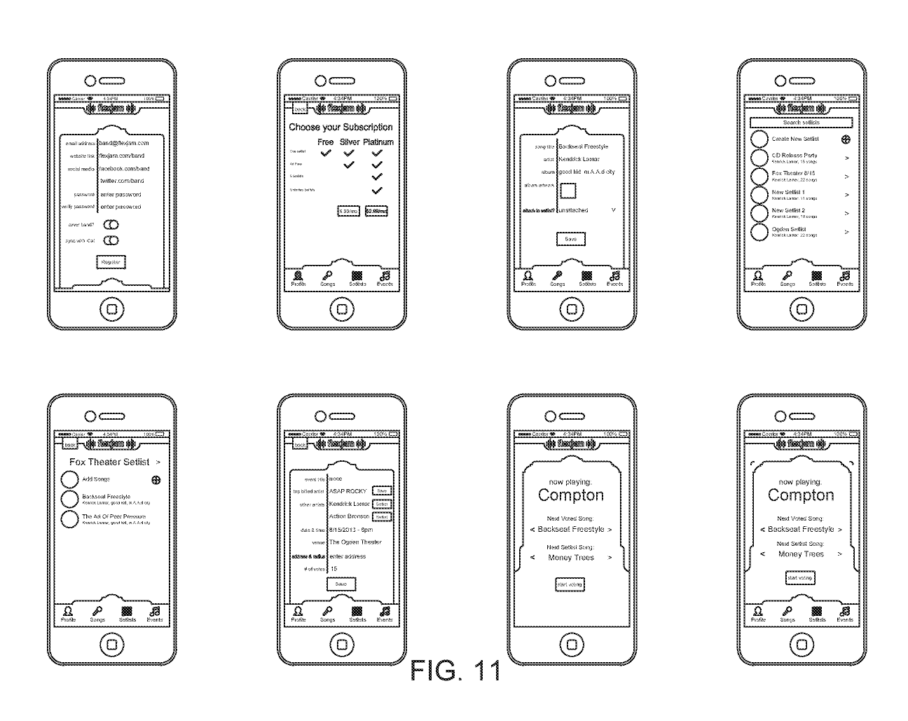

FIGS. 8-11 illustrate prophetic examples of a plurality of screenshots (on a touchscreen module device and thus a graphical user interface (GUI)) of a live fan-artist interaction system (FIGS. 8 and 9 showing how some screens may be linkable/navigable to each other using arrows between the screenshots), according to one embodiment of the invention. The illustrated screenshots show how users are able to make particular selections, view specific information, provide influence information (e.g. voting), register, login, associate information with their account, display schema information, associate information with social media, make purchases, search, create events, display event information, etc. and thereby interact with the system, before, during or after a particular event.

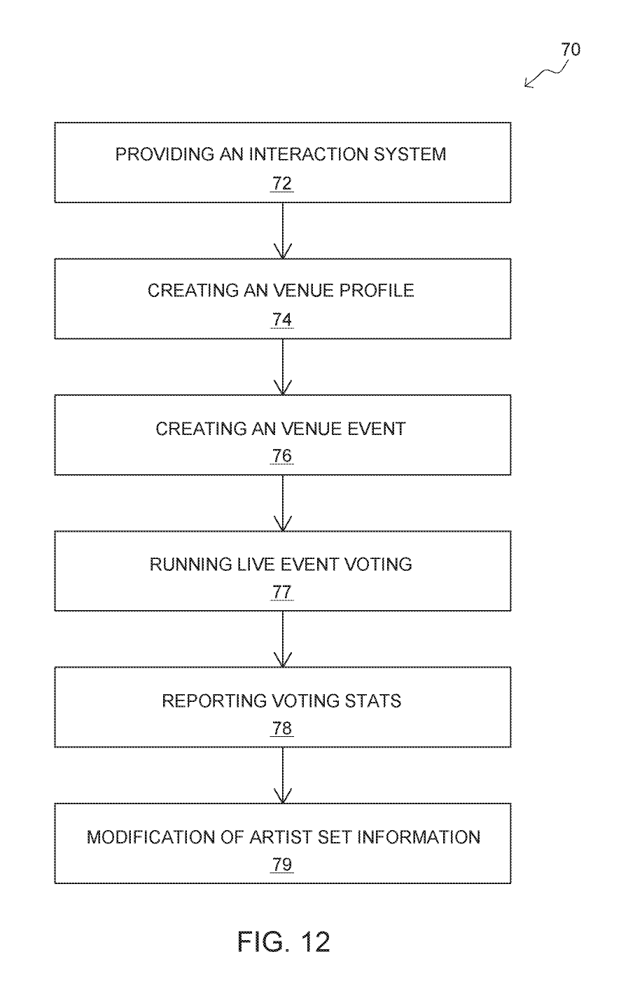

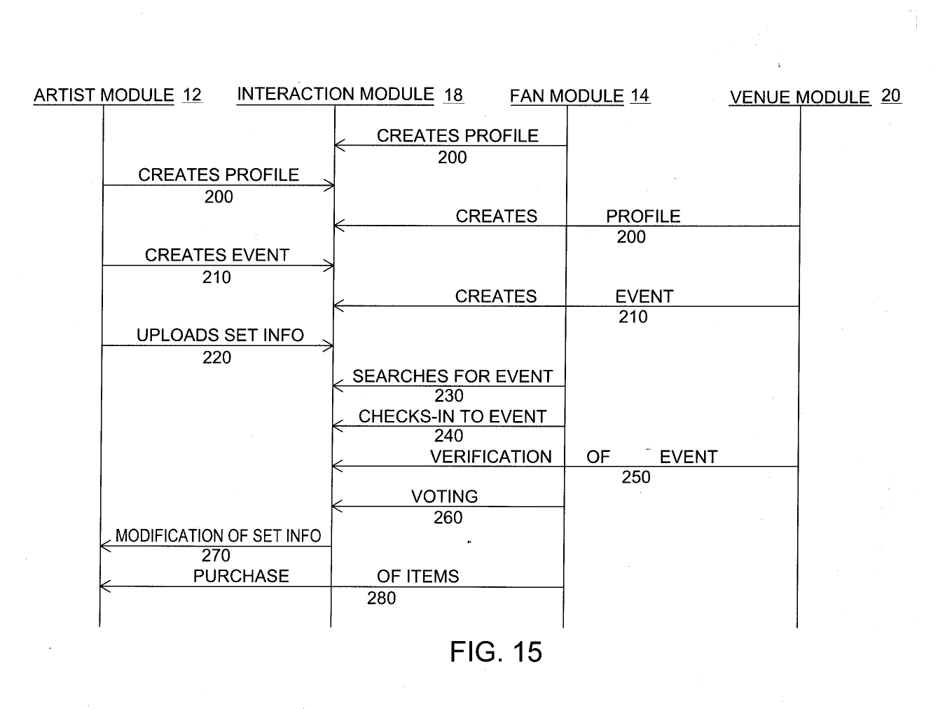

FIGS. 12-14 are flowcharts showing creation and use of fan and artist profiles, respectively. FIG. 15 illustrates such modules in interoperation with each other. In each, an interaction system is provided, which may include one or more of the modules described herein. Access to the system is provided to the various user through user interfaces, generally GUI within an app running on a portable computing device. Then a profile is created within the system based on prompts and information from the fan/artist (or could be for a venue). This may be accomplished by storing linked information about the fan/artist within an electronic database. Such information may include metadata about the fan/artist, e.g. name, contact information, social media information, social media login information, preferences, device settings, security information, links to other profiles/accounts, historical information, event attendance information, payment information, permissions, ticket information, saved queries, and the like and combinations thereof. Then an event is either created (e.g. by the artist or venue) or selected (by the fan). The event profile may contain a plurality of information about the event, including but not limited to name, contact information, social media information, social media login information, preferences, device settings, security information, links to other profiles/accounts, historical information, event attendance information, payment information, permissions, ticket information, saved queries, and the like and combinations thereof.

The artist may set parameters for a set-list that may include options/alternatives with respect to specific set information, e.g. which songs are played in which order, how equipment is to be configured during the event. The artist then activates the event and allows the fans to interact with the event and thereby with the artist, since the artist and equipment supporting the artist are functionally linked to the system. The system modifies set information on the fly and thereby allows the artist to also do so. At the event, the fan may check into the event and then may interact with the system during the event (e.g. voting on which songs should be in the set list).

Looking specifically to FIG. 12 as an example, according to one embodiment of the invention, there is a method of providing a live fan-artist interaction during a live artist performance 70. The method includes the step of providing a live fan-artist interaction system 72. The system includes an artist module that may have set information stored in a memory device. The system includes a plurality of fan modules each may have a user interface module that each solicits set modification information in real-time during a live artist performance. The system includes an interaction module functionally coupled over a computerized network to each of plurality of fan modules and the artist module such that the interaction module may receive set modification information from the plurality of fan modules, which thereby determines set modification instructions and may transmit set modification instructions to the artist module in real-time during a live artist performance. The artist module modifies set information according to set modification instructions in real-time during a live artist performance. The system includes a venue module functionally coupled to the plurality of fan modules and to the interaction module such that the venue module verifies check-in at a venue for each of the plurality of fan modules and limits communication between the interaction module and any fan modules not check-in verified.

The method includes the step of creating a venue profile through the venue module over a computerized network 74. The method includes the step of creating a venue event (e.g. when there is a venue-centric event like a festival where many artists are invited) through the venue module over a computerized network 76. The method includes running a live event display, contemporaneous in time with voting on set modification instructions, for interaction between the plurality of fan modules and the artist module through the interaction module over a computerized network 77. The method includes the step of running a report on set modification instructions from data solicited from the plurality of fan modules 78. The method includes the step of sending set modification instructions to the artist module over a computerized network 79.

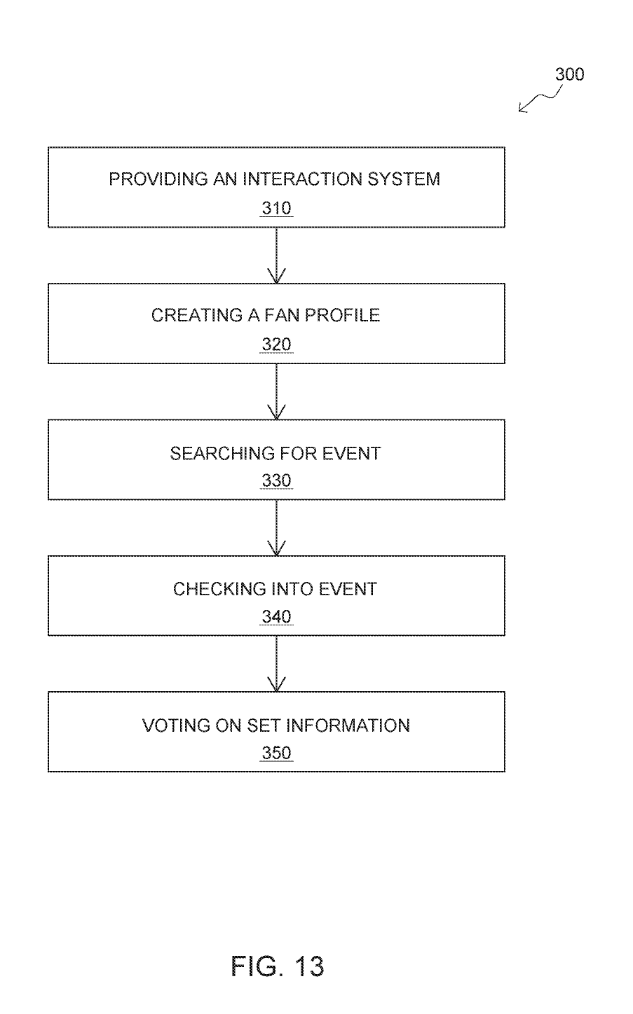

Looking to FIG. 13, the illustrated method includes providing an interaction system 310, which may include one or more of the modules described herein. The illustrated method also includes creating a fan profile 320, which may include receiving and storing fan information in association with an account and/or database record. The illustrated method also includes searching for an event 330, which may be automatic or at a request of a fan and may include one or more queries performed against one or more databases or other searchable materials and then reporting search results to the fan over a user interface. The illustrated method also includes checking into an event 340, which may include issuing a query against a database of registered attendees for a match based on identifying information stored in the fan profile and/or notifying a computerized system that a particular fan is in attendance. The illustrated method also includes voting on set information 350, which may include providing voting information over a user interface, receiving one or more selections over a user interface, and communicating the one or more selections to one or more other modules within the system.

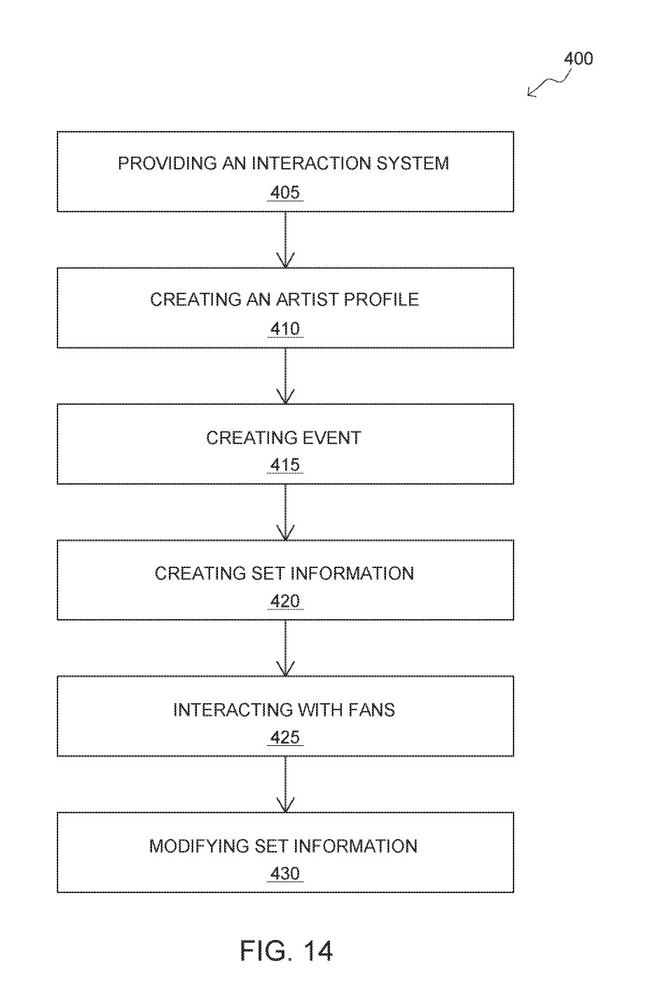

Looking to FIG. 14, the illustrated method includes providing an interaction system 405, which may include one or more of the modules described herein. The illustrated method also includes creating an artist profile 410, which may include receiving and storing artist information in association with an account and/or database record. The illustrated method also includes creating an event 415, which may include generating a record and/or account associated with a particular event and storing data associated therewith therein and then publicizing the event account/record over the system so that it may be accessed by others. The illustrated method also includes creating set information 420, which may include generating an account or record and populating the same with organized set information. As a non-limiting example, the system could store a plurality of Cordozar Calvin Broadus, Jr. cover songs in a particular order when creating set information 420. The illustrated method also includes interacting with fans 425, which may include providing selection option information over a network to a plurality of fan portable computing devices and then receiving selection information based on what selections they each made. The illustrated method also includes modifying set information 430, which may include altering a set information record/entry and publishing the updated information and/or allowing real-time access to that information to one or more other modules.

Looking to FIG. 15, there is shown a sequence diagram of a live fan-artist interaction method, according to one embodiment of the invention. There is shown a sequence diagram between an artist module 12, an interaction module 18, a fan module 14, and a venue module 20 of a live fan-artist interaction system over a computerized network.

The illustrated sequence diagram begins with an artist module 12, a fan module 14, and a venue module 20 creating profiles with an interaction module 18 of a live fan-artist interaction system over a computerized network 210. Then the artist module 12 and/or the venue module 20 creates an event for a live artist performance at a particular venue and date. The artist module 12 uploads set information to the interaction module 18 for disbursement through the live fan-artist interaction system to solicit fan modification 220.

The sequence diagram includes the fan module 14 searching for events 230 and checking-in to a live artist performance event 240 through the interaction module 18. The interaction module 18 verifies with the venue module 20 the geo-location of the fan module 250; thereby verifying and allowing access to the fan module to modify set information. The fan module 14 is now able to vote on upcoming songs or interact with the artist 260 through the interaction module 18. The set modification instructions or information is sent to the artist module from the interaction module; wherein the set modification instruction or information is displayed on a live event display module 270 in real-time. The fan module 14 also facilitates purchase of items 280 from the artist module.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A live fan-artist interaction system, comprising:
a) an artist module including set information stored in a memory device;
b) a plurality of fan modules each including a user interface module that each solicits set modification information in real-time during a live artist performance;
c) an interaction module functionally coupled over a computerized network to each of plurality of fan modules and the artist module such that the interaction module receives set modification information from the plurality of fan modules, which thereby determines set modification instructions and transmits set modification instructions to the artist module in real-time during a live artist performance; wherein the artist modifies set information according to set modification instructions in real-time during a live artist performance; and
d) a venue module functionally coupled to the plurality of fan modules and to the interaction module such that the venue module verifies check-in at a venue for each of the plurality of fan modules and limits communication between the interaction module and any fan modules not check-in verified.

2. The system of claim 1, wherein check-in at a venue is verified by polling geo-location from the associated fan module.

3. The system of claim 1, wherein each fan module includes a performance rating module that stores real-time rating information.

4. The system of claim 1, wherein each fan module includes a purchase module to facilitate purchases over a computerized network.

5. The system of claim 1, further comprising a plurality of artist profiles, fan profiles, and venue profiles.

6. The system of claim 1, wherein the artist module includes a live event display module that displays and updates set information in real-time.

7. The system of claim 1, wherein the artist module includes a production instruction module that automatically updates equipment configuration and communicates the same to audio equipment.

8. A live fan-artist interaction system, comprising:
a) an artist module including set information stored in a memory device; wherein the artist module includes a live event display module that displays and updates set information in real-time;
b) a plurality of fan modules each including a user interface module that each solicits set modification information in real-time during a live artist performance; and
c) an interaction module functionally coupled over a computerized network to each of plurality of fan modules and the artist module such that the interaction module receives set modification information from the plurality of fan modules, which thereby determines set modification instructions and transmits set modification instructions to the artist module in real-time during a live artist performance; wherein the artist modifies set information according to set modification instructions in real-time during a live artist performance.

9. The system of claim 8, further comprising a venue module functionally coupled to the plurality of fan modules and to the interaction module such that the venue module verifies check-in at a venue for each of the plurality of fan modules and limits communication between the interaction module and any fan modules not check-in verified.

10. The system of claim 9, wherein check-in at a venue is verified by polling geo-location from the associated fan module.

11. The system of claim 10, wherein each fan module includes a performance rating module that stores real-time rating information.

12. The system of claim 11, wherein each fan module includes a purchase module to facilitate purchases over a computerized network.

13. The system of claim 12, further comprising a plurality of artist profiles, fan profiles, and venue profiles.

14. The system of claim 13, wherein the artist module includes a production instruction module that automatically updates equipment configuration and communicates the same to audio equipment.

15. A method of providing a live fan-artist interaction during a live artist performance, comprising the steps of:
a) providing a live fan-artist interaction system, comprising:
a1) an artist module including set information stored in a memory device;
a2) a plurality of fan modules each including a user interface module that each solicits set modification information in real-time during a live artist performance;
a3) an interaction module functionally coupled over a computerized network to each of plurality of fan modules and the artist module such that the interaction module receives set modification information from the plurality of fan modules, which thereby determines set modification instructions and transmits set modification instructions to the artist module in real-time during a live artist performance; wherein the artist modifies set information according to set modification instructions in real-time during a live artist performance; and
a4) a venue module functionally coupled to the plurality of fan modules and to the interaction module such that the venue module verifies check-in at a venue for each of the plurality of fan modules and limits communication between the interaction module and any fan modules not check-in verified;
b) creating a profile for an artist through the artist module over a computerized network;
c) creating an event for a live artist performance; wherein the step of creating an event includes the step of picking a venue from a venue profile;
d) creating set information for the plurality of fan modules to modify and interact therewith over a computerized network;
e) facilitating voting on set modification instructions over a computerized network;
f) running a live event display, contemporaneous in time with voting on set modification instructions, for interaction between the plurality of fan modules and the artist module through the interaction module over a computerized network;
g) running a report on set modification instructions from data solicited from the plurality of fan modules; and
h) sending set modification instructions to the artist module over a computerized network.

16. A method of providing a live fan-artist interaction during a live artist performance, comprising the steps of:
a) providing a live fan-artist interaction system, comprising:
a1) an artist module including set information stored in a memory device;
a2) a plurality of fan modules each including a user interface module that each solicits set modification information in real-time during a live artist performance;
a3) an interaction module functionally coupled over a computerized network to each of plurality of fan modules and the artist module such that the interaction module receives set modification information from the plurality of fan modules, which thereby determines set modification instructions and transmits set modification instructions to the artist module in real-time during a live artist performance; wherein the artist modifies set information according to set modification instructions in real-time during a live artist performance; and
a4) a venue module functionally coupled to the plurality of fan modules and to the interaction module such that the venue module verifies check-in at a venue for each of the plurality of fan modules and limits communication between the interaction module and any fan modules not check-in verified;
b) creating a fan profile through the fan module over a computerized network;
c) searching for a venue or artist through the fan module over a computerized network;
d) checking into a venue over a computerized network;
e) interacting with the interaction module; wherein interacting with the interaction module includes the step of voting and rating songs by an artist during a live artist performance;
f) purchasing voting credits through a purchase module over a computerized network; and
g) purchasing merchandise through the purchase module from the artist module over a computerized network.

17. A method of providing a live fan-artist interaction during a live artist performance, comprising the steps of:
a) providing a live fan-artist interaction system, comprising:
a1) an artist module including set information stored in a memory device;
a2) a plurality of fan modules each including a user interface module that each solicits set modification information in real-time during a live artist performance;
a3) an interaction module functionally coupled over a computerized network to each of plurality of fan modules and the artist module such that the interaction module receives set modification information from the plurality of fan modules, which thereby determines set modification instructions and transmits set modification instructions to the artist module in real-time during a live artist performance; wherein the artist modifies set information according to set modification instructions in real-time during a live artist performance; and
a4) a venue module functionally coupled to the plurality of fan modules and to the interaction module such that the venue module verifies check-in at a venue for each of the plurality of fan modules and limits communication between the interaction module and any fan modules not check-in verified;
b) creating a venue profile through the venue module over a computerized network;
c) creating a venue event through the venue module over a computerized network;
d) running a live event display, contemporaneous in time with voting on set modification instructions, for interaction between the plurality of fan modules and the artist module through the interaction module over a computerized network;
e) running a report on set modification instructions from data solicited from the plurality of fan modules; and
f) sending set modification instructions to the artist module over a computerized network.
